(19) United States
(12) Patent Application Publication
(10) Pub. No.: US 2012/0172163 A1
(43) Pub. Date: Jul. 5, 2012

(54) ELASTOMERIC SPRING PULLEY ASSEMBLY FOR ROTARY DEVICES

(76) Inventor: Frank A. Fitz, Poway, CA (US)

(21) Appl. No.: 12/981,359

(22) Filed: Dec. 29, 2010

(51) Int. Cl. F16H 55/36

(52) U.S. Cl. 474/94

(57) ABSTRACT

A pulley assembly for a rotary device such as an automotive alternator comprising a pulley, a hub, and one or more elastomeric springs to cushion and attenuate the effect of sudden rotational velocity variations of the pulley and the hub. Premature spring failure is prevented by a mechanical stop arrangement that limits the amount of relative rotation between the pulley and hub to prevent over-compression of the springs.

### BACKGROUND

This invention relates generally to pulley assemblies for rotary devices, and more particularly to pulley assemblies for driving rotary devices, such as automotive alternators, which use elastomeric springs to cushion and attenuate the effects of abrupt rotational velocity changes

Some systems which employ rotary prime movers as drivers for providing rotational motive power for driving accessory rotary devices are characterized by cyclic dynamic torque characteristics which result in rotational perturbations that are transmitted to the rotary accessory devices. An example of such systems is an internal combustion engine that drives rotary accessory devices such as an alternator, air-conditioning compressor, water pump, etc. Rotation of the engine crankshaft is transmitted via a serpentine or poly-V drive belt system to pulleys attached to the drive shafts of such accessory devices to rotate their shafts. The rotation of an internal combustion engine crankshaft is subject to perturbations, the magnitude and frequency of which varies with engine RPM. During combustion, the crankshaft temporarily speeds up and generates a pulse of rotational power that is transmitted via the belt to the rotary accessories. During compression, the crankshaft temporarily slows down while the inertia of the rotary devices tends to maintain initially the rotational velocities of the devices. The cyclic acceleration and deceleration of the crankshaft imparts a corresponding pulsed driving characteristic to the drive belt system and to the pulley assemblies of the rotary accessory devices. Generally, the slower the rotational speed of the crankshaft or the fewer the number of cylinders, the greater the pulse effect. At engine idle, for instance, the magnitude of the variations is the greatest and the effects are most noticeable.

Crankshaft pulsations are transmitted to the drive belt system and the driving pulleys of accessory devices as sudden, dynamic rotational velocity fluctuations. The inertias of the rotary devices tend to resist the velocity fluctuations, which generates dynamic tensions in the belt as it tries to accelerate and decelerate the rotary devices to accommodate the fluctuations. The fluctuations are transmitted to the shafts of the rotary devices through their pulleys, and may produce undesirable belt slippage, noise and vibration that are transmitted to a passenger compartment, as well as cause wear and tear on the rotary devices and the belt. This results in higher than desirable belt wear and shortens the life of both the belt and the rotary devices. Automotive alternators are particularly susceptible to increased wear and decreased life due to such fluctuations because of their high inertia and their high rotational speed and their variable load and torque, and they tend to fail frequently.

One approach to addressing the problem of dynamic fluctuations and reduced life of rotary devices, such as automotive alternators, has been to employ one-way clutch decouplers in the pulleys of the devices. One version of these decoupler pulleys incorporates a simple one-way clutch in the pulley. Conventional one-way clutches are mechanical devices that engage when the pulley rotates in the driving direction but disengage when the pulley rotates in the opposite direction relative to the shaft so that the shaft may overrun. One-way clutches accommodate crankshaft slowdown reasonably well since they disengage the pulley from the shaft and overrunning permits the shaft to continue rotating under the inertia of the alternator shaft and armature. However, one-way clutches do not satisfactorily accommodate abrupt increases in speed, as when combustion occurs, because they engage suddenly and attempt to accelerate the shaft rotation rapidly to match the increased belt velocity. This results in vibration, noise, high wear and frequent failure of a one-way clutch, and may shorten the life of the bearings of the rotary devices, as well as the life of the drive belt. One-way clutches used in high frequency loading environments, such as in alternators which lock and release several times per engine revolution, have high failure rates, as do other components of drive systems employing one-way clutches. Moreover, one-way clutches do not eliminate the problems of rotational velocity fluctuation, noise and vibration since they address only belt deceleration but not belt acceleration.

An approach to address these problems has been to employ pulley assemblies using springs formed of elastomeric materials comprising natural or synthetic rubbers and polymers to compensate for sudden relative bi-directional rotational angular velocity differences between the pulley and the shaft of the rotary device However, premature failures of some elastomeric springs have occurred in use, impairing the ability of the pulley assembly to cushion rapid rotational velocity changes.

There is a need for pulley assemblies employing elastomeric springs that address the foregoing and other problems of cushioning sudden relative bi-directional rotational angular velocity differences between a pulley and a rotating shaft to reduce noise, vibration and wear, and that do not exhibit premature failure of the springs. It is to these ends that the present invention is directed.

### SUMMARY OF THE INVENTION

The invention affords pulley assemblies employing one or more elastomeric springs that address the foregoing and other problems of loss of the ability of a pulley assembly to cushion and attenuate the effects of sudden rotational velocity variations due to failure of an elastomeric spring.

It has been discovered that failure of elastomeric springs in pulley assemblies of the type to which the invention pertains is due in significant part to the design of the pulley assemblies which allowed rotation of the pulley relative to the hub until rotation was halted by fully compressing or deforming the springs between the pulley and hub. Thus, the design allowed the springs to be repeatedly over-compressed during operation of the pulley assembly in reacting to sudden relative rotational velocity changes. Over-compression caused the elastomeric material from which the springs are formed to deteriorate and lose its resiliency, thereby resulting in spring failure and a loss of the ability to attenuate and cushion the impact of relative velocity changes.

In one aspect, the invention affords a method of preventing the failure of an elastomeric spring in a pulley assembly comprising limiting the amount of spring compression produced by relatively moveable members of the pulley assembly. In particular, compression of the spring is limited to a predetermined amount that is less than full compression.

In a more specific aspect, the spring is disposed between the relatively moveable members, and the method comprises mechanically limiting the movement of the moveable members by a predetermined amount in a direction that compresses the spring.

In another aspect, the invention affords a pulley assembly comprising an elastomeric spring disposed between relatively moveable members, and a mechanical stop for limiting the amount of relative movement of the relatively moveable members by a predetermined amount in a direction that compresses the spring.

In still another aspect, the invention provides a pulley assembly comprising a hub and a pulley disposed on the hub for relative rotation therewith. The hub and the pulley have respective cooperating portions that form a chamber in which an elastomeric spring is disposed, and the pulley assembly has a mechanical stop for limiting the relative rotation of the pulley and the hub by a predetermined amount in a direction that reduces the volume of the chamber to limit the compression of the spring.

In a more specific aspect, the mechanical stop comprises relatively moveable components respectively associated with the pulley and the hub that engage to prevent rotation of the pulley and the hub by more than said predetermined amount. The pulley assemblies operate bidirectionally in both drive and drag directions, and afford predetermined amounts of cushioning and attenuation of the effects of sudden relative rotational velocity changes due to relative accelerations and, if desired, decelerations of a pulley driver and the shaft of a rotary device. The one or more elastomeric springs allow the pulley and the shaft to remain positively engaged while permitting bidirectional relative rotation by maintaining a direct resilient coupling between the pulley and the drive shaft in one or both of a driving and an over-run direction, to accommodate and cushion abrupt rotational velocity changes, and that smoothly counteracts the changes to restore equilibrium, thereby affording greater control of the relative rotations of the pulley and the shaft.

### BRIEF DESCRIPTION OF THE DRAWINGS

FIG. 1 is a perspective view of a pulley assembly for a rotary device in accordance with a first embodiment of the invention;

FIG. 2 is an exploded perspective view of the pulley assembly of FIG. 1 that illustrates the components of pulley assembly;

FIG. 3 is a diagrammatic transverse cross-sectional view of the pulley assembly of FIG. 1 taken approximately along the line 3-3 of FIG. 4;

FIG. 4 is a longitudinal cross-sectional view of the pulley assembly of FIG. 1 taken approximately along the lines 4-4 of FIG. 3;

FIG. 5 is a perspective view of an embodiment of a hub of the pulley assembly of FIG. 2;

FIG. 6 is a perspective view of a pulley of the pulley assembly of FIG. 2;

FIG. 7 is a graph illustrating a relationship between torque and shaft displacement for the pulley assembly of FIGS. 2-6;

FIGS. 8A-8B are, respectively, a diagrammatic transverse cross-sectional view of a pulley assembly, and a perspective view of one form of a mechanical stop of the pulley assembly, in accordance with a second embodiment of the invention;

FIGS. 9A-9B are, respectively, a side elevation view of a hub, and an end view of a pulley assembly that uses the hub in accordance with a third embodiment of the invention;

FIG. 10 is a diagrammatic transverse cross-sectional view of a pulley assembly in accordance with a fourth embodiment of the invention; and

FIG. 11 is a diagrammatic transverse cross-sectional view of a pulley assembly in accordance with a fifth embodiment of the invention.

### DESCRIPTION OF PREFERRED EMBODIMENTS

The invention is particularly well adapted for use in automotive applications and will be described in that context. It will be appreciated, however, that this is illustrative of only one utility of the invention, and that the invention has broader applicability to other applications that are characterized by pulsed rotational variations or velocity perturbations of rotary devices and drivers.

As will be described in more detail below, preferred embodiments of pulley assemblies in accordance with the invention employ spring members formed of resilient elastomeric materials comprising natural or synthetic rubbers or polymers, that afford resilient coupling and relative rotation of a pulley and a hub (and the shaft of the rotary device on which the hub is mounted) to compensate for rotational perturbations of the drive engine and the rotary device.

Pulley assemblies in accordance with the invention afford bidirectional relative rotation and predetermined attenuations of the effects of sudden relative rotational velocity changes between the pulley and the rotary device due to relative accelerations and decelerations of the engine and the rotary device. The resilient elastomeric springs allow the pulley and the shaft to remain positively engaged while permitting relative rotation and maintaining a direct coupling between the pulley and the drive shaft. The pulley assemblies accommodate abrupt rotational velocity changes and, due to spring resiliency, smoothly counteract the changes to restore equilibrium. In momentary steady-state (neutral) conditions, the crankshaft of the internal combustion engine, the pulley and rotary device shaft are rotating at a nominal speed which is a function of the ratio of the diameters of the driven pulley and the crankshaft pulley. Upon the engine crankshaft suddenly accelerating, as during a combustion stroke, there is a substantially instantaneous (typically within a fraction of a second) increase in its rotational velocity in a drive direction that is transmitted to the pulley through the drive belt. The pulley, in turn, attempts to impart the sudden rotational velocity change to the rotary device. However, the inertia of the shaft of the rotary device tends to resist abrupt rotational speed changes, causing a sudden impact and vibration and noise as the drive belt attempts to abruptly change the rotational velocity of the shaft. This effect is particularly evident in an automotive alternator, for example, since the rotor of the alternator typically has a large mass and high inertia, and is subject to variable average torque due to varying alternator electrical loads.

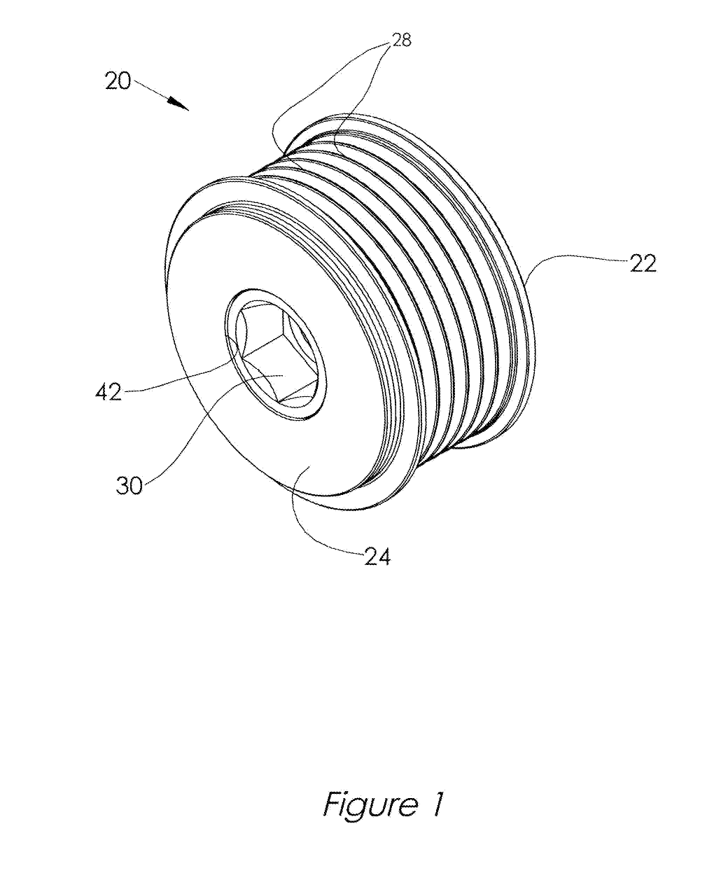

Generally, the pulley assemblies according to the invention employ elastomeric (polymer) springs and are operative in both driving and drag directions. They allow the pulley to accelerate or decelerate suddenly and rotate relative to the hub and shaft, i.e., displace, by a predetermined relative angular rotation, as will be described, while remaining resiliently coupled. (Some embodiments of the present invention, however, such as the first embodiment of FIGS. 1-7, may not employ springs and resilient coupling operating in the drag direction, and may over-run in this direction.) Thus, the sudden acceleration or deceleration of the pulley is not transmitted to the shaft. Rather, the resilient coupling between the pulley and the hub/shaft permits substantially instantaneous relative angular rotation or displacement between the pulley and shaft. When the relative angular velocity of the pulley and the rotational deviation between the pulley and the shaft increases, as during a driving cycle (e.g., combustion), the elastomeric springs coupling the pulley and the shaft through the hub are increasingly deformed and compressed and they exert an increasing force on the hub and shaft due to their resiliency. This causes a smoothly increasing engagement between the pulley and shaft and a corresponding smoothly increasing acceleration of the shaft to match the rotational velocity of the pulley. Thus, sudden impulses to the pulley are attenuated and cushioned so that abrupt speed changes are transmitted more gradually to the shaft over a range of angular rotations, thereby reducing or substantially eliminating abrupt force variations in the belt and corresponding vibration and noise.

When the rotational velocity of the pulley decreases, as during compression, the resilient coupling between the pulley and the shaft is operative in the opposite (drag) direction to permit relative rotation or displacement so that the abrupt deceleration of the pulley will not be transmitted to the shaft. As described above for accelerations, the elastomeric springs can attenuate and cushion rotational velocity changes due to abrupt deceleration of the pulley so that they are not imparted directly to the shaft

FIGS. 1-7 illustrate a first embodiment of a pulley assembly 20 in accordance with the invention. The pulley assembly 20 comprises a pulley 22 rotatably disposed on a hub 30 for relative rotation therewith. The hub is adapted to be located on the end of a drive shaft (not illustrated) of a rotary device, such as an automotive alternator, and the pulley 22 is adapted to be driven in a well known manner by a drive belt (not illustrated), such as a serpentine or poly-V drive belt, of an internal combustion engine to rotate the shaft. As best shown in FIGS. 1, 2 and 6, the pulley 22 may comprise a cup-shaped member, comprising a cylindrical tubular barrel (for a serpentine drive belt) having a plurality of circumferential ribs and grooves 28 formed about its exterior surface that are adapted to mate with corresponding ribs and grooves of a serpentine belt (not shown) to rotate the pulley, and having an annular end portion 24 integrally formed with the cylindrical barrel. For other types of drive belts, e.g., poly V-belts or chains, the pulley may have other appropriate external configurations.

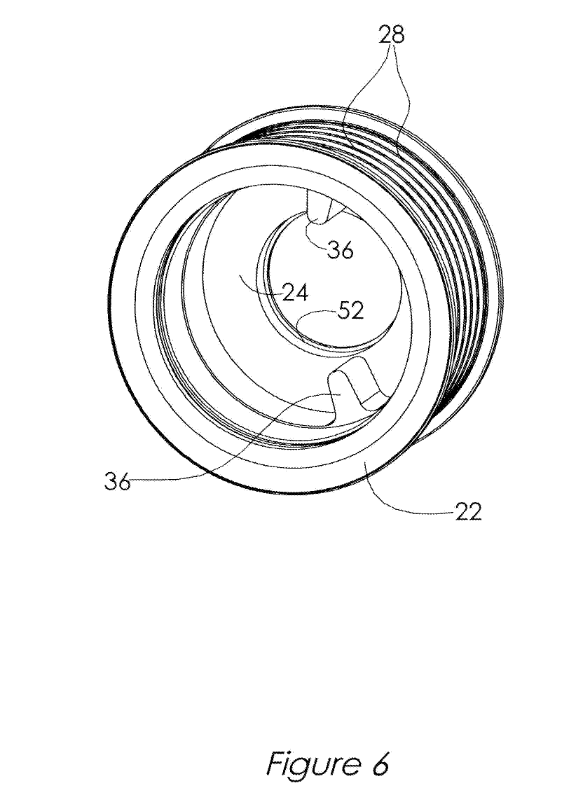

The pulley may have a plurality of radially inwardly directed projections 36, 36′ extending from its inner circumferential surface. The first embodiment preferably has two projections 36 and 36′ disposed about the inner circumference of the pulley. As shown the projection may be disposed asymmetrically (non-evenly spaced) about the inner circumference. The projections may have a somewhat rounded triangular cross-sectional shape, have a bar shape when viewed from their longitudinal (axial) side, and may extend axially a short distance along the along the inner circumferential surface of the pulley, as shown in FIG. 6. As will be described, other embodiments may employ different numbers of projections, different arrangements of projections, and projections of different shapes.

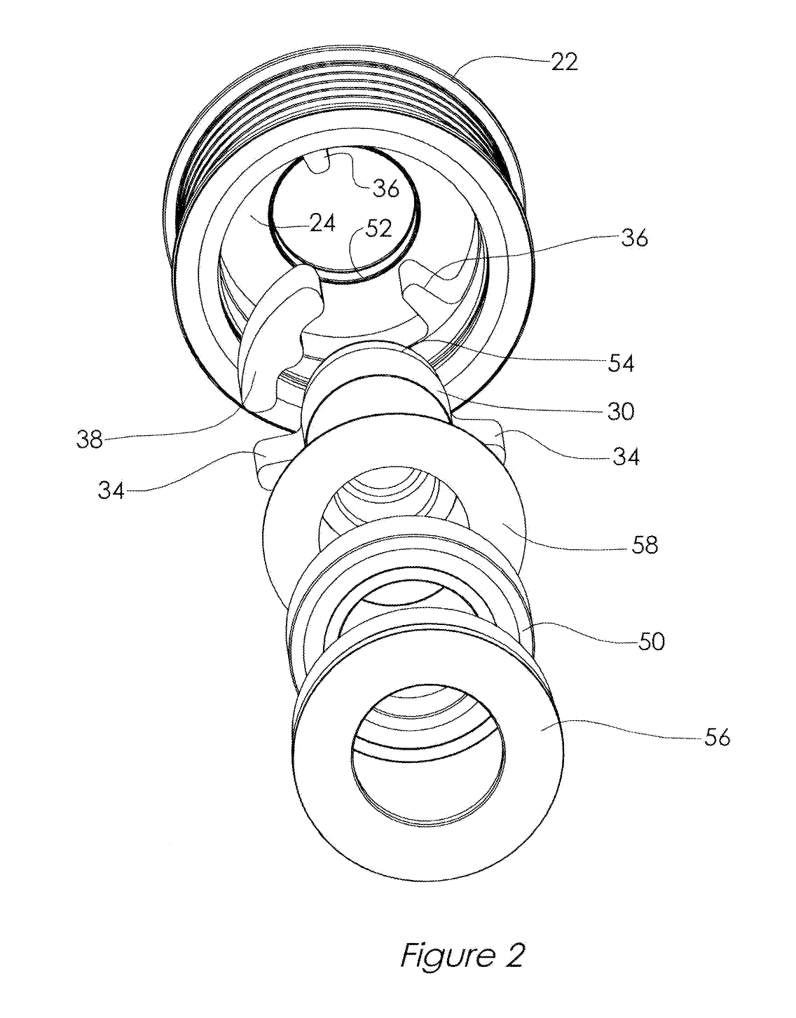

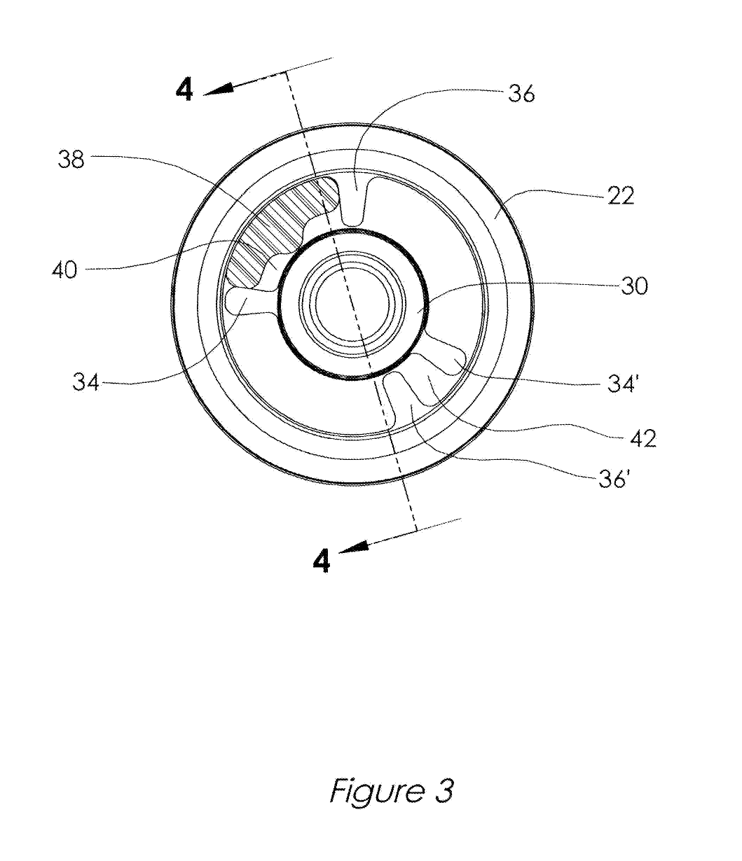

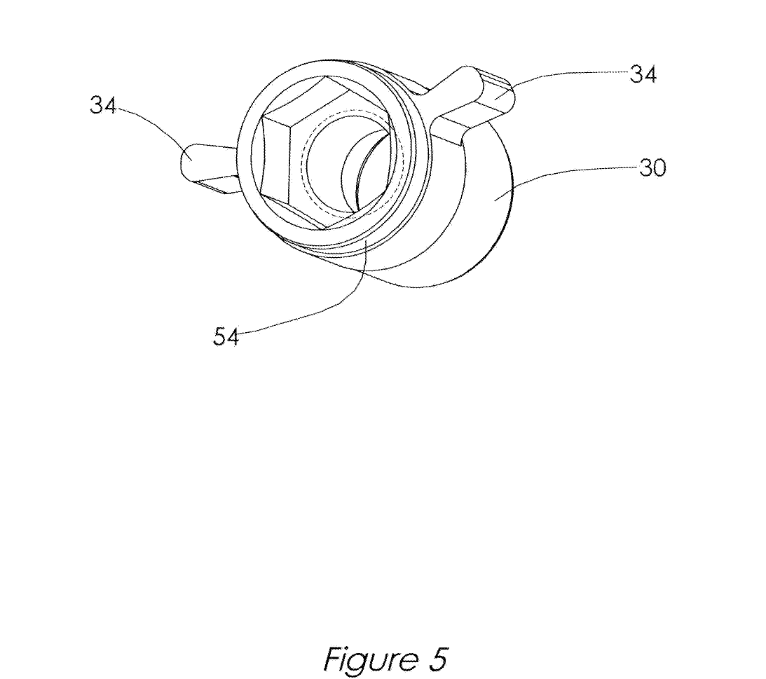

The hub 30 preferably has a generally cylindrical tubular shape, as shown in FIGS. 2 and 5. It is adapted to be connected to the shaft of a rotary device, such as an alternator, and to be disposed concentrically within the interior of the pulley 22. The pulley may be supported for limited relative rotation on the hub, as will be described. The hub may have a plurality of radially outwardly directed projections 34, 34′ extending from its exterior circumferential surface (there being two such projections in the first embodiment), as best illustrated in FIGS. 3 and 5. Projections 34, 34′ may have a paddle-like cross-sectional shape and a bar shape when viewed axially, and they may extend axially a short distance along the outer circumferential surface of the hub. As with projections 36, 36′ of the pulley, the projections 34, 34′ may be asymmetrically disposed (non-evenly spaced) about the outer circumference of the hub.

When assembled with the pulley, projections 34, 34′ of the hub 30 and projections 36, 36′ of the pulley 22 are interleaved, as shown in FIG. 3. The interleaved projections form cavities or chambers that change in size and shape upon relative rotation of the pulley and hub. As shown in FIG. 3, a resilient elastomeric spring 38 formed of natural or synthetic rubbers or polymers is disposed in a chamber formed between the adjacent projections 34 and 36. The resilient spring affords a springy coupling between the pulley and the hub (and the shaft) in a drive direction of the pulley (counter-clockwise (“CCW”) in FIG. 3 relative to the hub) and permits resilient relative angular rotation of the pulley and shaft over a predetermined angular range in the drive direction, as will be described. The absence of an elastomeric spring in other ones of the chambers formed between the projections means that in a drag direction (clockwise (“CW”) in FIG. 3) there is no resilient coupling and the hub free-runs relative to the pulley within the rotational limits defined by the projections. As will be described, other embodiments of pulley assemblies according to the invention may employ springs operative in both drive and drag directions, different numbers of cooperating projections, different numbers of springs, and springs with different characteristics to afford different resilient coupling in the drive and drag directions (CCW and CW, respectively, in FIG. 3).

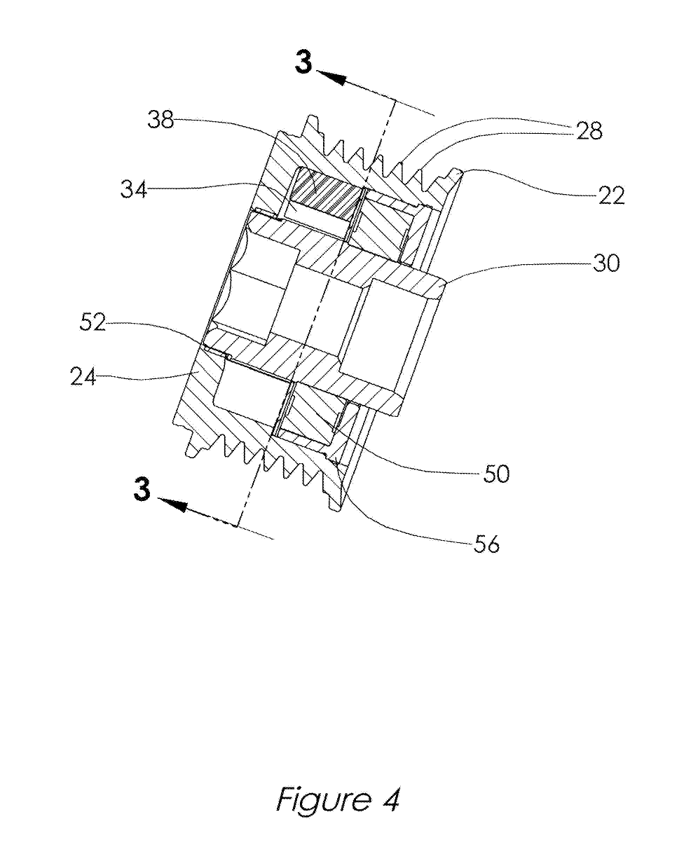

The end of the shaft of the rotary device (not shown) may be threaded, and hub 30 may be mounted on the shaft in a conventional manner, as with a nut threaded onto the shaft. Pulley 22 may be rotationally supported on the shaft concentrically about the hub by a first bearing 50 at the rear or right end (in the FIG. 4) of the pulley assembly adjacent to the rotary device housing (not shown), and by a second bearing surface 52 formed in the end 24 of the pulley that mates with a corresponding bearing surface 54 on the forward or left end of the hub. As shown in FIGS. 2 and 4, bearing 50 may be disposed within a corresponding cup-shaped bearing sleeve 56, and spaced from the hub by an annular washer 58.

As noted above, in the first embodiment illustrated in FIGS. 2-6, there are two cooperating projections 34, 36 formed on each of the exterior of the hub and the interior of the pulley, respectively, that form a chamber 40 for the elastomeric spring 38. The projections 34 and 36 may be located on the hub and the pulley so that chamber 40 has any desired size in the circumferential (angular) direction, and so that the spring 38 may be sized to fit snugly within the chamber when the pulley and hub are in a neutral position, as shown in FIG. 3. The spring size, shape and the elastomeric materials from which it is formed may be selected to provide desired spring characteristics. The spring volume relative to the chamber 40 between the projections 34, 36 also determines the resilient properties of the pulley assembly and the characteristics of the resilient coupling between the pulley and the hub. The projections 34 and 36 cooperate with the spring member 38 to afford resilient relative rotation of the pulley and the hub (and shaft) over a predetermined angular range in the drive direction of the pulley (CCW in FIG. 3), as will be described.

A second pair of cooperating projections 34′, 36′ may be located on the hub and pulley, respectively, non-evenly (non-symmetrically) spaced angularly about the circumferences of the hub and pulley relative to the projections 34 and 36, respectively, as shown in FIGS. 2, 3, 5 and 6. As best illustrated in FIG. 3, projections 34′ and 36′ are located such that a space 42 formed between projections 34′, 36′ has a smaller angular extent than does chamber 40 formed between projections 34, 36. In the embodiment shown in FIGS. 2-6, space 42 may have an angular extent of the order of 20°, for example, whereas the angular extent of the chamber 40 may be substantially greater, e.g., for example by three or four times or more. Chamber 40 may be sized to accommodate a spring having a size, a shape and a volume to afford desired spring characteristics and cushioning for the particular application in which the pulley assembly is used.

The projections 34, 36 cooperate with the spring member 38 to afford resilient relative rotation of the pulley and the hub (and shaft) over a predetermined angular range in the drive direction of the pulley (CCW in FIG. 3). As the pulley suddenly accelerates and rotates relative to the hub during a driving (combustion) cycle, the inertia and load of the rotary device to which the hub is connected resist the velocity change. The resilient coupling between the pulley and the hub afforded by the spring 38 allows the pulley to accelerate and rotate substantially instantaneously relative to the hub when combustion occurs. Thus, projections 34 and 36 move towards one another, reducing the angular extent and volume of chamber 40. This resiliently deforms and compresses spring 38 between projections 34, 36, which causes the spring to exert a force on the hub causing the shaft of the rotary device to accelerate to the speed of the pulley. The compression of the spring cushions and attenuates the noise and vibration which would otherwise be caused by the sudden change in rotational velocity of the pulley relative to the hub. During sudden deceleration of the pulley, as during a compression cycle, the load on the rotary device will also cause its shaft, and, thus, the hub, to also decelerate somewhat and continue to compress spring 38, although to a lesser degree. The amount of decompression will be determined by the amount of deceleration of the hub, which will depend upon the load on the rotary device and its inertia. Typically, the spring will not fully decompress. Thus, the first embodiment of the pulley assembly shown in FIGS. 2-6 has no other springs that react to deceleration of the pulley and rotation relative to the hub in a CW direction (in FIG. 3) as during a compression or drag cycle. In the event that the spring did decompress, which could occur with a small load and high inertia of the rotary device, the hub would be able to free run relative to the pulley by an angular amount determined by either the circumferential (angular) distance between projections 34 and 36′ or between projections 34′ and 36, whichever is smaller.

In some known pulley assemblies that employ elastomeric springs, particularly those used on automotive alternators, the springs tend to fail more frequently than desired or expected. When the springs fail, they lose their resiliency and are no longer able to cushion and attenuate noise and vibration. Attempts to address such failures have primarily focused on finding improved elastomeric materials, and various natural and synthetic rubbers and other materials have been explored. These attempts have been met with varying degrees of success.

It has been discovered, however, that a principal cause of the failure of elastomeric springs in such pulley assemblies is due to repeated over-compression of the springs. The relative rotation between the pulley and the hub compresses the springs and subjects the elastomeric material to high stresses that are determined by the amount of compression. Over-compression occurs when, for a given elastomeric material, repeated compression of the springs by a particular amount adversely affects the properties of the elastomeric material and causes it to lose its resiliency prematurely. For a given spring configuration and elastomeric material, the amount of compression that results in over-compression can be determined empirically.

Accordingly, the invention affords pulley assemblies constructed to limit the compression elastomeric springs so that they are not over-compressed. The invention avoids over-compression by limiting the amount of relative movement of movable members within the pulley assembly which compress the springs so that the springs are compressed to a predetermined amount which is below that amount for which repeated compression produces loss of resiliency. This is accomplished by incorporating mechanical mechanisms, e.g., mechanical stops, that limit the amount of compression of the elastomeric springs to prevent over-compression.

In the first embodiment shown in FIGS. 2-6, projections 34′ and 36′ cooperate to form a mechanical stop that limits the rotation of the pulley relative to the hub and shaft of the rotary device in the drive direction to a predetermined angular amount determined by the angular separation between the projections. As the pulley rotates relative to the hub in a drive direction, projection 36′ moves towards projection 34′ until the projections engage. The amount of rotation is determined by angular separation between the projections, which may be about 20°, for example, in this first embodiment. By spacing the projections on the pulley and the hub appropriately, the angular extent of cavity 42 between projections 34′, 36′ can be made less than that of chamber 40 which houses the spring. Engagement of the projections 34′ and 36′ limits rotation of the pulley relative to the hub to less than the angular extent of chamber 40, which in turn limits the amount of compression of the spring 38 by projections 34 and 36. In the absence of mechanical limit imposed by projections 34′, 36′, the pulley could rotate CCW relative to the hub during a drive cycle until the spring 38 was fully compressed to the point that it could be compressed no further. At this point, the bulk spring material itself would limit further relative rotation.

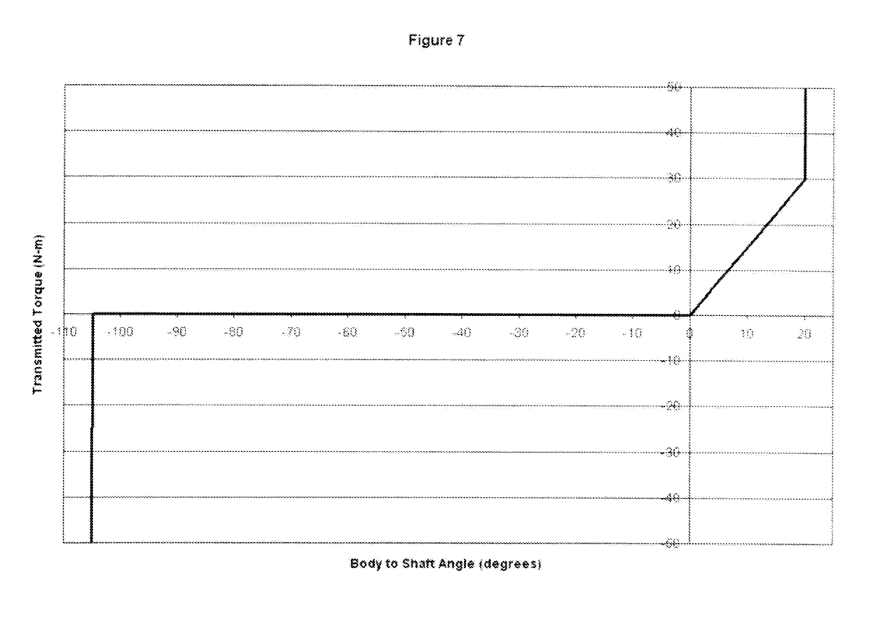

FIG. 7 illustrates the relationship between torque and hub/shaft displacement for the first embodiment of FIGS. 2-6. As shown in FIG. 7, for 0° relative angular displacement between the pulley and the hub (shaft), the torque is substantially zero. The driving direction is to the right of the 0° relative angular displacement position in the figure, and the drag or free-running direction is to the left. For automotive applications where the pulley assembly is used to drive rotary devices such as an alternator, the operating mid point is typically somewhere on the upwardly sloped portion of the torque curve to the right of 0°. Upon the occurrence of a driving event, such as the combustion cycle of the engine when the pulley's rotational velocity suddenly increases, the torque transmitted to the shaft of the rotary device by the pulley increases substantially linearly as shown in the figure over an angular range of approximately 20° corresponding to the angular separation between the projections 34′ and 36′ (the angular extent of cavity 42). When the projections engage at approximately +20°, further relative rotation between the pulley and hub/shaft is stopped and the torque increases vertically in a positive direction to a limit determined by the prime mover.

In the opposite drag direction (to the left in FIG. 7) from the operating point on the upwardly sloped torque curve, upon a sudden deceleration of the pulley, the load on the rotary device will typically also cause the shaft/hub to decelerate, as previously described, although not as rapidly and not as much as the pulley. Thus, the torque applied to the spring will decrease, although it will not normally decrease to zero, reducing the compression of the spring. Thus, normally, the pulley assembly will operate on the linear portion of the torque curve above and below its neutral operating point. However, under some operating conditions, such as idle of the engine and low loads, the hub/shaft may not slow sufficiently to maintain the spring in compression during a non-driving (drag) cycle, allowing the relative angular deviation between the pulley and the hub to go negative. Since in the first embodiment there are no springs that engage the projections in the drag direction, the hub may free run relative to the pulley for a very short angular distance into the operational range where no torque is transmitted until either projections 34 and 36′ engage or projections 36 and 34′ engage, depending upon which pair of projections has the smallest angular separation. For the first embodiment, engagement occurs at approximately −105° as shown in FIG. 7, at which point the engaging projections constitute a mechanical stop that prevents further relative rotation, and the torque increases vertically in a negative direction, as shown in the figure. Since the velocity difference between pulley and hub is relative small, the force of the impact of the projections in the drag direction, and, accordingly the noise and vibration produced, is much smaller than in the drive direction and much less objectionable.

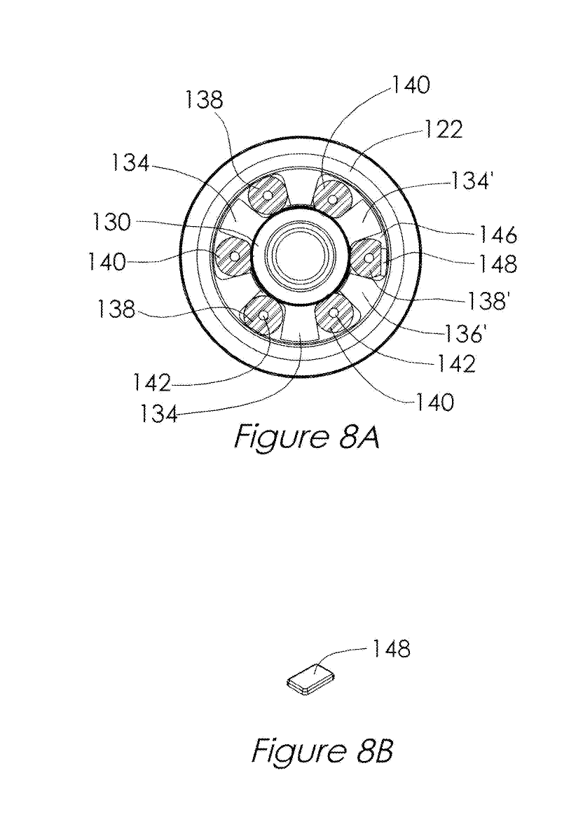

FIGS. 8A-B illustrate a second embodiment of a pulley assembly employing a mechanical stop in accordance with the invention. As shown in FIG. 8A, a pulley 122 may have a plurality of three radially inwardly directed projections 136 symmetrically disposed about its inner circumference that cooperate with a corresponding plurality of three radially outwardly directed projections 134 which may be symmetrically disposed about the outer circumference of the hub. The projections 134, 136 may be interleaved circumferentially to form corresponding chambers between them. Elastomeric springs 138, 140 are located in alternating chambers, and, therefore, the springs are operative in both driving and drag directions. The spring characteristics of the springs are determined, in large part, by their sizes, shapes, material characteristics and volumes. In this second embodiment, the elastomeric springs 138, 140 may have a solid cylindrical shape with a centrally disposed axial hole or void 142, as shown. The hole 142 is used to adjust the volumes of the springs, and, thus, the spring characteristics of the pulley assembly. In contrast to the first embodiment, the pulley assembly of the second embodiment of FIGS. 8A-B exhibits bidirectional resilient operation in both driving and drag directions. Springs 138 are operative to cushion the impact of abrupt relative velocity changes in the drive direction, and springs 140 are operative to cushion relative velocity changes in the opposite drag direction. The springs 138 and 140 may have the same or different spring characteristics.

The second embodiment of FIGS. 8A-B also incorporates a mechanical stop arrangement to limit relative rotation of the pulley and hub/shaft in a driving direction to a predetermined amount that prevents over-compression of the springs. This stop arrangement comprises forming at least one of the cylindrical springs 138′ between a pair of projections 134′, 136′ to have an axial portion of its outer side removed to form a flat 146 adjacent to the inner circumferential surface of the pulley, as shown in FIG. 8A, and disposing a substantially flat hard, non-compressible, insert 148, such as a metal bar, (shown in FIG. 8B) into the space between the flat 146 and the inner surface of the pulley, as shown. Insert 148 functions as a mechanical stop that prevents full compression of the springs and affords a predetermined controlled amount of compression. Upon rotation of the pulley in a driving direction (CCW in the figure) relative to the hub, as during a combustion stroke of the engine, pulley projections 136 move towards hub projections 134, compressing the springs 138 in the spaces between the projections to cushion and attenuating the noise and vibration due to the change in relative velocities. At a predetermined relative angular rotation of the pulley and hub determined by the size of insert 148 in a circumferential direction, the insert will engage adjacent projections 134′ and 136′ to prevent further relative rotation and compression of the springs 138, 138′. By appropriately sizing the insert relative to the angular separation between the projections, it limits the relative angular rotation of the pulley and hub to a predetermined amount that is less than that which over-compresses the springs.

When the pulley velocity suddenly slows, as during a compression stroke, the load on the rotary device may cause it to decelerate also and maintained the springs somewhat compressed in the driving direction, as described above. In some cases, the inertia of the rotary device and its load may be such that the hub initially tends to maintain substantially the same rotational velocity. In this case, the slowing rotation of the pulley in this drag direction relative to the hub causes projections 134 to move towards projections 136. This may compress springs 140 in the alternating chambers to cushion and attenuate the impact of the relative rotational velocity changes in the drag direction if the perturbation is of sufficient magnitude to involve these drag direction springs.

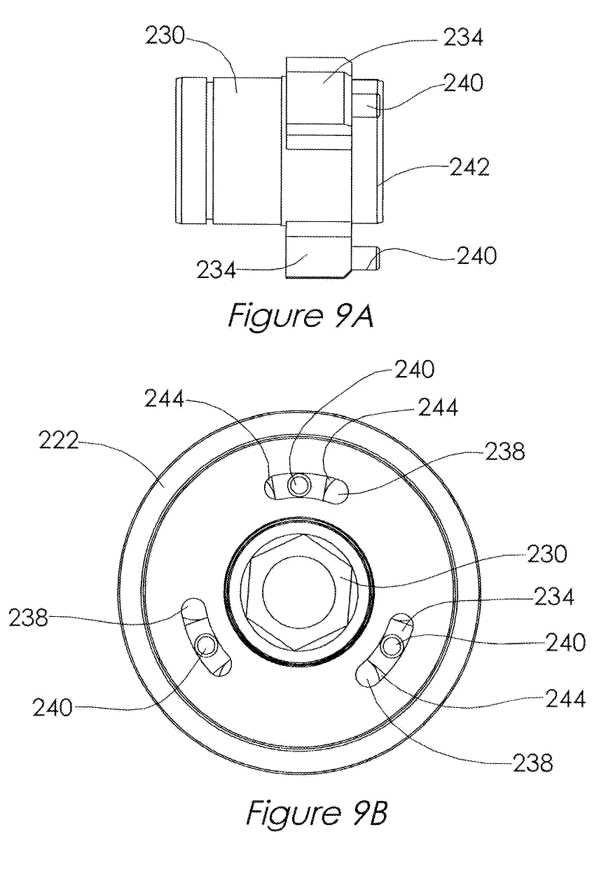

FIGS. 9A-B illustrate a third embodiment of a pulley assembly in accordance with the invention having a mechanical stop mechanism to limit the relative rotation and compression of elastomeric springs to a predetermined amount. This third embodiment may have a pulley, hub, and spring arrangement similar to the second embodiment of FIG. 8A, and also operates bidirectionally as does the second embodiment.

FIG. 9A is a side elevation view of a hub 230 in accordance with a third embodiment of the invention, and FIG. 9B is an interview of a pulley 222 in accordance with the third embodiment. Hub 230 may have a plurality of radially extending projections 234, for example, three, which may be symmetrically disposed about the circumference of the hub. Each projection 234 may have an axially projecting post or stud 240 extending from the projection 234 towards an end 242 of the hub. When the hub is assembled with the pulley, the studs 240 are adapted to project through corresponding arcuate-shaped openings or slots 244 formed in the end plate 224 of the pulley, as shown in FIG. 9B. Each stud 240 and slot 244 cooperates to form a mechanical stop arrangement that limits the amount of bidirectional relative rotation between the pulley and the hub and the amount of compression of springs 238 disposed in chambers located between projections 234 and corresponding projections (not illustrated) formed on the interior circumference of the pulley, similar to that shown in FIG. 8A. Slots 244 may have an angular extent in the end plate corresponding to the desired amount of maximum relative bidirectional angular rotation between the hub and the pulley, for example, plus (+) and minus (−) 20° about the zero displacement position shown in FIG. 9B. While the mechanical stop arrangement of the third embodiment is shown as having three studs 240 and three corresponding arcuate shaped slots 244, it will be appreciated that fewer or greater numbers of studs and slots may be employed. An advantage of having three studs and slots, as illustrated, is that this distributes symmetrically about the pulley and hub the forces occasioned by the studs engaging the ends of the slots.

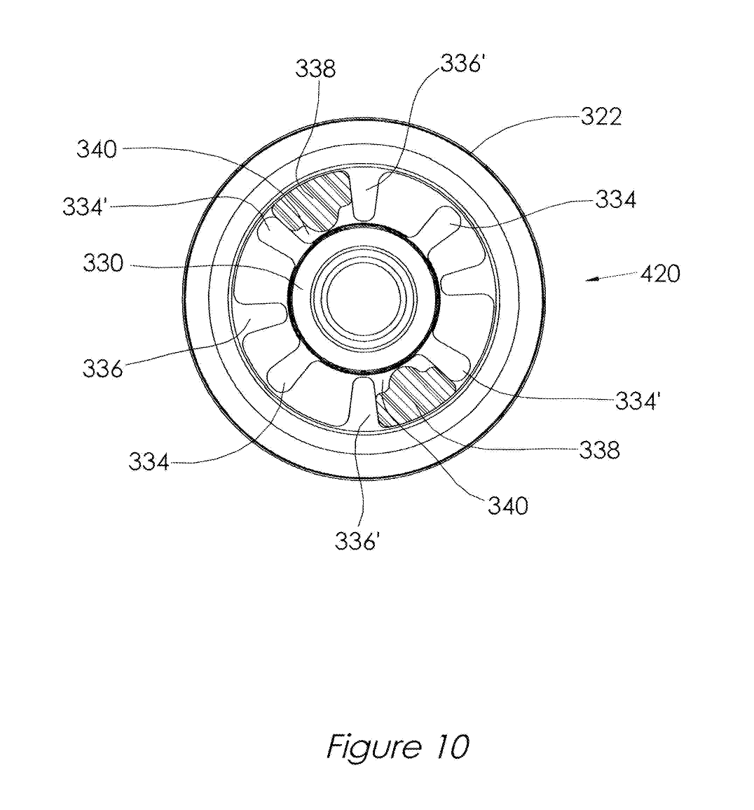

FIG. 10 illustrates a fourth embodiment of a pulley assembly 320 in accordance with the invention. Pulley assembly 320 is similar to the first embodiment of the invention illustrated in FIGS. 2-6, except that it employs symmetrically located springs 338 for cushioning noise and vibration produced by relative rotation of a pulley 322 and a hub 330 in a drive direction. As shown in the figure, pulley 322 may have four radially inwardly extending projections 336, 336′ symmetrically disposed about its inner circumference that are interleaved with and cooperate with four radially outwardly extending projections 334, 334′ symmetrically disposed about the outer circumference of the hub 330. In the form illustrated in FIG. 10, springs 338 of the fourth embodiment may each be approximately one-half the size (circumferentially) of spring 38 of the first embodiment and may have a similar cross sectional shape to that of the first embodiment. The chambers 340 formed between projections 334′ and 336′ in which the springs 338 are disposed are likewise approximately one-half the size of chamber 40 of the first embodiment to accommodate the smaller sized springs. The other two sets of projections 334, 336 of the hub and pulley, respectively, constitute a mechanical stop arrangement that operates similar to that of the first embodiment to limit relative angular rotation of the pulley and hub to a predetermined amount sufficient to prevent over-compression of the springs. Adjacent projections 334, 336 of each set are disposed on the circumferences of the hub and the pulley separated by an angular distance (in a neutral position) corresponding to the desired maximum predetermined amount of relative rotation between the pulley and the hub in a drive direction.

Upon acceleration of the pulley 322 during a drive cycle and rotation of the pulley relative to the hub, projections 336′ move towards cooperating projections 334′ to compress springs 338 in the intervening chambers 340. Compression of springs 338 cushions and attenuates the noise and vibration that otherwise would result from the sudden differences in rotational velocities of the pulley and the hub. Additionally, adjacent projections 334, 336 move towards one another until they close the space between themselves and engage, thereby limiting the amount of relative rotation between the pulley and hub and, correspondingly, limiting the compression of springs 338. The symmetrically located springs 338 of the fourth embodiment of FIG. 10 have the advantage of evenly distributing the forces applied to the pulley and the hub upon relative rotation of the pulley and hub, evenly cushioning and attenuating the noise and vibration due to relative velocity changes between the pulley and the hub. Although springs 338 are approximately one-half the size of spring 38 the of first embodiment, the two springs acting together may exert approximately the same restoring force to the pulley and hub as does the single spring 38 of the first embodiment. Each of the springs 338, however, experiences a greater amount of compression than does the single larger spring 38 of the first embodiment. Furthermore, the angular extent of relative rotation in a drag direction between the pulley and the hub is reduced because of the smaller angular distances between the two sets of projections 334′-336 and 334′-336. However, these two sets of projections, acting together, also distribute the forces applied to the pulley and hub more evenly when they engage in a drag direction.

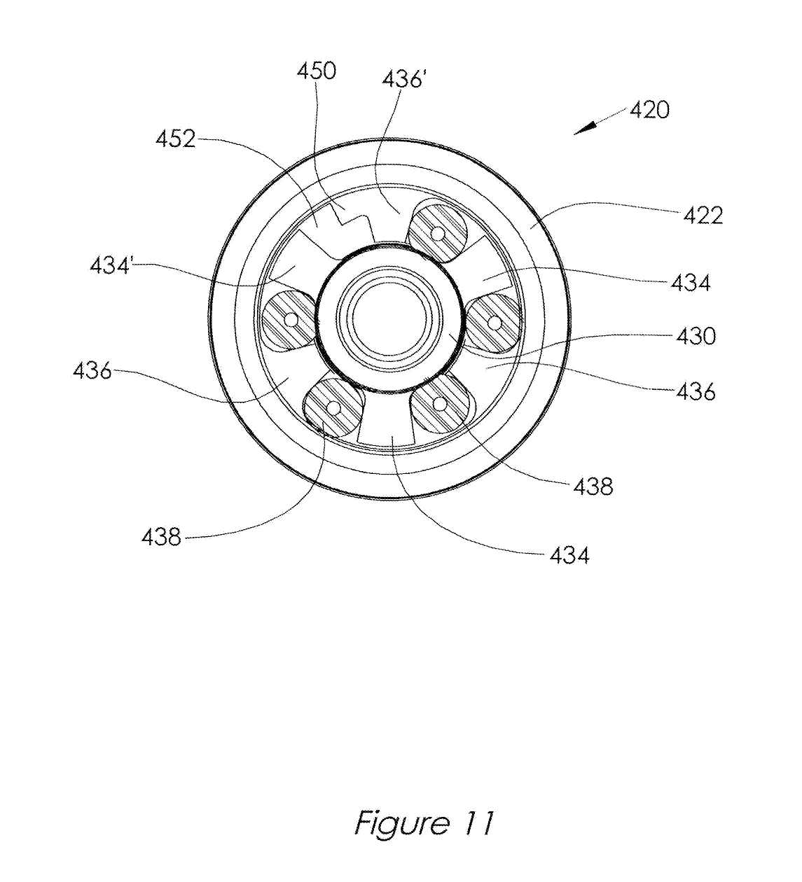

FIG. 11 illustrates a fifth embodiment of a pulley assembly 420 in accordance with the invention. As shown, pulley assembly 420 comprises a pulley 422 and a hub 430, each of which has a plurality of radially extending projections 434, 436 that form corresponding chambers 440 in which elastomeric springs 438 are disposed. The fifth embodiment is similar to the second embodiment of FIGS. 8A-B in that the pulley and the hub each have three symmetrically located projections, and the springs are in the form of cylinders having a central axial openings. The fifth embodiment differs, however, from the second embodiment in the structure of the mechanical stop arrangement that it employs.

As shown in FIG. 11, one of the projections 436′ of the pulley may be shaped to have an abutment 450 that extends in a counterclockwise (drive) direction into the space 452 between projection 436′ and another cooperating projection 434′ of the hub, and the space 452 may not have a spring 438. Upon acceleration of the pulley 422 in a counterclockwise direction during a drive cycle, projections 436 of the pulley move towards projections 434 of the hub, compressing the springs 438 in the chambers between them, until abutment 450 of projection 436′ engages projection 434′. This engagement prevents further relative rotation of the pulley and the hub, and constitutes a mechanical stop that limits the compression of the springs. The amount of relative angular rotation between the pulley and the hub in the drive direction is limited by the angular extent of the space between abutment 450 and projection 434′. By sizing abutment 450 to afford a predetermined angular extent of the space 450 between the abutment and projection 434′, the amount of relative rotation between the pulley and the hub in a drive direction, and, accordingly, the amount of compression of springs 438, may be controlled.

As may be appreciated from the foregoing, by mechanically limiting the amount of compression of the elastomeric springs in a pulley assembly, the invention provides a simple and elegant solution to the problem of spring failure due to repeated over-compression of the springs.

Although the invention has been described in the context of an automotive application where rotating devices are driven by a drive belt and an internal combustion engine, it will be appreciated that the invention has other applications, and may be used effectively to cushion and attenuate the effects of sudden rotational velocity changes in other types of systems driven by many other types of prime movers. For example, the invention may be used to advantage in other applications where a high mass device, like an alternator rotor, is being driven in a rotationally fluctuating system to attenuate the effects of varying speeds.

While the foregoing has been with reference to particular described embodiments of the invention, it will be appreciated by those skilled in the art that changes to these embodiments may be made without departing from the principles of the invention, the scope of which is defined by the appended claims.

1. A method of preventing failure of an elastomeric spring in a pulley assembly comprising limiting the compression of the spring produced by relatively movable members of the pulley assembly such that the spring is not over-compressed.

2. The method of claim 1, wherein said limiting comprises limiting compression of the spring to a predetermined amount that is less than full compression of the spring.

3. The method of claim 1, wherein said limiting comprises limiting repeated over-compression such that the elastomeric spring material loses its resiliency.

4. The method of claim 1, wherein the spring is disposed between the relatively movable members, and said limiting comprises mechanically limiting relative movement of the members in a direction that compress the spring.

5. The method of claim 4, wherein said mechanically limiting comprises employing a mechanical stop that prevents movement of said movable members more than a predetermined amount in said direction that compresses the spring.

6. The method of claim 1, where said limiting comprises limiting compression during driving of the pulley assembly.

7. A method of preventing failure of an elastomeric spring which cushions the impact of relative rotational velocity changes between a pulley and a hub of a pulley assembly, comprising limiting the rotation of the pulley relative to the hub to a predetermined amount that prevents over-compression of the spring.

8. The method of claim 7, wherein said over-compression of said spring comprises compression of the spring such that the elastomeric material of the spring loses its resiliency.

9. The method of claim 7, wherein said limiting comprises mechanically limiting relative rotation of the pulley and the hub in a direction that compresses the spring.

10. The method of claim 9, where said mechanically limiting comprises preventing rotation of the pulley relative to the hub more than said predetermined amount through engagement with a mechanical stop.

11. A pulley assembly comprising an elastomeric spring disposed between relatively moveable members, and a mechanical stop arrangement for limiting the relative movement of the moveable members such that the spring is not over-compressed.

12. The pulley assembly of claim 11, wherein said over-compression comprises compression of the spring such that the elastomeric material of the spring loses its resiliency.

13. The pulley assembly of claim 11, wherein said moveable members comprise a pulley and a hub, the pulley adapted to be driven by a prime mover and to be disposed for rotation on the hub, the hub adapted to be connected to the shaft of a rotary device, and wherein said mechanical stop arrangement engages the pulley to prevent rotation of the pulley relative to the hub more than a predetermined amount in a driving direction.

14. The pulley assembly of claim 11, where the spring is disposed between a first projection of the pulley and a second projection of the hub, the spring being compressed between said projections upon rotation of the pulley relative to the hub, and said mechanical stop arrangement comprises third and fourth projections of the pulley and hub respectively that engage to prevent relative rotation of the pulley.

15. A pulley assembly for a rotary device, comprising:
a pulley adapted to be rotated by a drive belt, the pulley having a first plurality of radial projections extending from the pulley;
a hub disposed within the pulley for relative rotation therewith, the hub being connected to said rotary device and having a second plurality of radial projections extending from the hub, the first and second pluralities of projections being interleaved and forming a plurality of spaces therebetween;
an elastomeric spring disposed in one or more of said spaces, wherein upon relative angular rotation of the pulley and the hub one or more of said interleaved first and second projections resiliently compress said spring to cushion the impact of said relative angular rotations; and
a mechanical arrangement for limiting said relative rotation to prevent over-compression of the spring.

16. The pulley assembly of claim 15, wherein said over-compression comprises repeated compression of the spring by an amount such that the elastomeric material of the spring loses its resiliency.

17. The pulley assembly of claim 15, wherein said mechanical arrangement comprises a mechanical stop for preventing rotation of the pulley relative to the hub by more than a predetermined amount.

18. The pulley assembly of claim 17, wherein said mechanical stop comprises at least first and second adjacent ones of said projections being located an angular distance apart corresponding to said predetermined amount so that they engage to prevent further relative rotation.

19. The pulley assembly of claim 17, wherein one or more of the second projections of the hub have an axially extending stud that is located within an arcuate slot in the pulley, the slot being sized such that the stud engages an end of the slot upon relative rotation corresponding to said predetermined amount.

20. The pulley assembly of claim 17, wherein said mechanical stop comprises at least one said projections having a circumferentially projecting portion that engages an adjacent projection upon relative rotation by said predetermined amount.

21. The pulley assembly of claim 11, wherein said elastomeric spring is disposed between moveable members that move together to compress the spring during driving of the pulley in a driving direction, and there are no springs in the pulley assembly that are compressed in a non-driving direction.

22. The pulley assembly of claim 15, wherein said elastomeric spring is compressed by said projections upon rotation of the pulley in a driving direction relative to the hub, and there are no springs in the pulley assembly that are compressed upon rotation of the pulley relative to the hub in a non-driving direction.
